(19) United States
(12) Patent Application Publication
(10) Pub. No.: US 2016/0328452 A1
(43) Pub. Date: Nov. 10, 2016

(54) APPARATUS AND METHOD FOR CORRELATING CONTEXT DATA

(71) Applicant: NOKIA TECHNOLOGIES OY, Espoo (FI)

(72) Inventors: David NGUYEN, Santa Clara, CA (US); Praveen KRISHNAN, Sunnyvale, CA (US)

(21) Appl. No.: 15/109,893

(22) PCT Filed: Jan. 23, 2014
(86) PCT No.: PCT/US14/12832

§ 371 Date: Jul. 6, 2016

(51) Int. Cl. G06F 17/30; H04W 8/18

(52) U.S. Cl. CPC G06F 17/30528; H04W 8/18

(57) ABSTRACT

A method, apparatus and computer program product are provided in accordance with an example embodiment in order to determine a recommended action to be taken based on contextual data. In the context of a method, contextual data is received regarding a user's situation. The method also determines at least one recommended action to be taken by the user based on the contextual data. The method further provides the at least one recommended action to the user. The recommended action may be determined in various manners including, for example, being based upon user data that is associated with contextual data that corresponds to the contextual data that has been received.

### TECHNOLOGICAL FIELD

Example embodiments of the present invention relate generally to managing and correlating data, such as contextual data regarding a user's situation, such as via the Internet of Things.

### BACKGROUND

Every day, people make decisions about what actions to take based on what is going on around them and what they plan to do. Many activities and behaviors are routine or habit-driven. A person may wake up, turn on the news, see what the weather is supposed to be, and plan his or her outfit for the day based on the forecast.

People also may experience the same conditions more than once. Because there may be several things going on in a person's life, three screaming children in the background, or a relatively long time between the same or similar experiences, a person may forget how he or she has handled the situation in the past.

### BRIEF SUMMARY OF EXAMPLE EMBODIMENTS

Accordingly, it may be desirable to provide tools that provide users with recommendations on actions that the user should take (e.g., tasks that should be performed, clothes that should be worn, items that should be packed, etc.) based on data gathered regarding the user's surroundings, the user's situation, and other contextual data. In this way, embodiments of the invention described herein can remind a user of things he or she has done in the past that are not being done presently, so as to allow the user to take the same actions that were helpful to the user previously in order to achieve a positive result.

In some embodiments, an apparatus is provided for receiving contextual data regarding a user's situation and providing recommended actions. The apparatus may include at least one processor and at least one memory including computer program code. The at least one memory and the computer program code may be configured to, with the processor, cause the apparatus to at least receive contextual data regarding a user's situation, determine at least one recommended action to be taken by the user based on the contextual data, and provide the at least one recommended action to the user.

The contextual data may comprise data detected by at least one sensor in a vicinity of the user or data received from a mobile terminal associated with the user. In some embodiments, the at least one memory and the computer program code may be configured to, with the processor, cause the apparatus to receive user data regarding an action taken by the user, wherein the user data is associated with corresponding contextual data. In some cases, the user data regarding an action taken by the user may comprise an indication of an object being in proximity to the user.

In some embodiments, the at least one memory and the computer program code may be configured to, with the processor, cause the apparatus to provide for storage of the user data received and the associated contextual data and further cause the apparatus to determine the at least one recommended action to be taken by the user based on stored user data associated with stored contextual data that corresponds to the contextual data received. In other embodiments, the at least one memory and the computer program code may be configured to, with the processor, cause the apparatus to provide for storage of the user data received and the associated contextual data and further cause the apparatus to determine a relationship between the user data and the associated contextual data, such that the at least one recommended action to be taken by the user is determined based on the relationship determined.

In some cases, the at least one memory and the computer program code may be configured to, with the processor, cause the apparatus to provide the at least one recommended action to the user by causing display of a notification to the user. The recommended action may comprise the user bringing a particular item to a destination.

In other embodiments, a method and a computer program product are provided for receiving contextual data regarding a user's situation and providing recommended actions. The method and computer program product may include receiving contextual data regarding a user's situation; determining at least one recommended action to be taken by the user based on the contextual data; and providing the at least one recommended action to the user. The contextual data may comprise data detected by at least one sensor in a vicinity of the user or data received from a mobile terminal associated with the user.

In some cases, the method and computer program product may further comprise receiving user data regarding an action taken by the user, wherein the user data is associated with corresponding contextual data. The user data regarding an action taken by the user may comprise an indication of an object being in proximity to the user.

The method and computer program product may further comprise providing for storage of the user data received and the associated contextual data, wherein determining the at least one recommended action to be taken by the user may comprise determining the at least one recommended action to be taken by the user based on stored user data associated with stored contextual data that corresponds to the contextual data received. Moreover, the method and computer program product may further comprise providing for storage of the user data received and the associated contextual data and determining a relationship between the user data and the associated contextual data, such that the at least one recommended action to be taken by the user is determined based on the relationship determined.

In some cases, providing the at least one recommended action to the user may comprise causing display of a notification to the user. The recommended action may comprise the user bringing a particular item to a destination.

In still other embodiments, an apparatus is provided for receiving contextual data regarding a user's situation and providing recommended actions. The apparatus may include means for receiving contextual data regarding a user's situation; means for determining at least one recommended action to be taken by the user based on the contextual data; and means for providing the at least one recommended action to the user. The apparatus may further comprise means for receiving user data regarding an action taken by the user, wherein the user data is associated with corresponding contextual data.

In some cases, the apparatus may further comprise means for providing for storage of the user data received and the associated contextual data, wherein the means for determining the at least one recommended action to be taken by the user comprise means for determining the at least one recommended action to be taken by the user based on stored user data associated with stored contextual data that corresponds to the contextual data received. In still other cases, the apparatus may further comprise means for providing for storage of the user data received and the associated contextual data and means for determining a relationship between the user data and the associated contextual data, such that the at least one recommended action to be taken by the user is determined based on the relationship determined. The user data regarding an action taken by the user may, for example, comprise an indication of an object being in proximity to the user.

In some embodiments, the means for providing the at least one recommended action to the user may comprise means for causing display of a notification to the user. Moreover, the recommended action may comprise the user bringing a particular item to a destination.

### BRIEF DESCRIPTION OF THE SEVERAL VIEWS OF THE DRAWING(S)

Having thus described example embodiments of the invention in general terms, reference will now be made to the accompanying drawings, which are not necessarily drawn to scale, and wherein:

FIG. 1 illustrates one example of a communication system according to an example embodiment of the present invention;

FIG. 2 illustrates a schematic block diagram of an apparatus for determining a recommended action based on contextual data according to an example embodiment of the present invention;

FIG. 3 illustrates a system for providing contextual data that is utilized to determine a recommended action according to an example embodiment of the present invention;

FIG. 4 illustrates an example of contextual data that may be received from various sources and that is associated with user data according to an example embodiment of the present invention;

FIG. 5 illustrates an example of contextual data that may be received from various sources and that is utilized to determine a recommended action according to an example embodiment of the present invention;

FIG. 6 is a perspective view of a mobile terminal that is configured to provide a recommended action to the user according to an example embodiment of the present invention; and

FIG. 7 illustrates a flowchart of methods of determining a recommended action based on contextual data according to an example embodiment of the present invention.

### DETAILED DESCRIPTION

Some example embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a physical storage medium (e.g., volatile or non-volatile memory device), can be differentiated from a “computer-readable transmission medium,” which refers to an electromagnetic signal.

Human beings are creatures of habit. People have routines that they follow for making decisions regarding what to wear, what to pack, what to carry, etc. in certain situations. For example, when a particular individual hears a weather forecast on a Wednesday morning that calls for no rain in the afternoon, that person, who typically plays soccer on Wednesdays after work, may need to leave home ten minutes earlier than he or she does on other days of the week so that he or she can drive to work rather than take the train. In addition, the user may also want to pack an extra snack to take to work so that he or she can eat it before the soccer game.

At the same time, however, people can be easily distracted, may forget what they need to do, or may not be able to get all of the information they need to accurately determine their situation, which may prevent them from being able to appropriately prepare themselves. In addition, the person may forget how they handled the same situation when it occurred two months ago and may find themselves approaching the situation as though for the first time, not knowing which actions may lead to success, and which ones may lead to failure or less than optimal results. For example, the person getting ready for their Wednesday may forget that it is Wednesday, may get caught up reading the paper and may turn on the news too late and miss the weather forecast, or may decide to buy lunch that day and, in the process, may forget to pack any snacks.

With so many factors involved in creating the context for the user's everyday decisions, it can be hard for the user to take consistent and reasonable actions to appropriately address his or her current situation. Moreover, the limited ability of a person to recall every single situation he or she has been in and what actions worked (and what didn't) may often cause a person to unknowingly take the wrong action, even though he or she had the experience to know what action should have been taken based on what has worked in the past.

Advancements in technology, however, have allowed more and more of the physical objects that a person may interact with (e.g., from complex devices such as smart phones, tablets, computers, etc. to simple physical items, such as articles of clothing, food items, etc.) to be connected to a network of objects (often referred to as the Internet of Things, or IoT). Any object, for example, can be connected to this network by equipping the object with a unique identifier, such as via a radio frequency identification (RFID) tag or using other techniques that can enable the object to be managed and inventoried by a computer, including near field communication (NFC) identifiers, barcodes, Quick Response (QR) codes, digital watermarks, etc. Through such a network, contextual data about a person's situation (e.g., where the person is, what the weather is like, what the person is eating or doing, etc.) can be gathered and stored to provide a detailed picture of the person's situation at any given point in time. Considering the large volume of data that may be used to define the person's situation, the task of sorting through the data over the course of one day, let alone over several days or weeks, to identify trends and/or historical data can be daunting, if not altogether impossible.

Accordingly, example embodiments of the present invention provide mechanisms for receiving contextual data regarding a user's situation and predicting the actions that the user should take in that particular situation. In conjunction with this contextual data, user data may also be received that describes one or more actions taken by a user in a particular situation (e.g., such that the user data is associated with certain contextual data). Using the example above, the user's situation may be a non-rainy Wednesday morning; however, in other examples, the user's situation may be preparations for a trip to visit the user's friend in Chicago or the day before a trip to the beach. The contextual data, as described in greater detail below, may be gathered from a variety of sources and may describe the user's situation, such that any action or actions that the user should take in response to his or her situation may be determined and provided to the user.

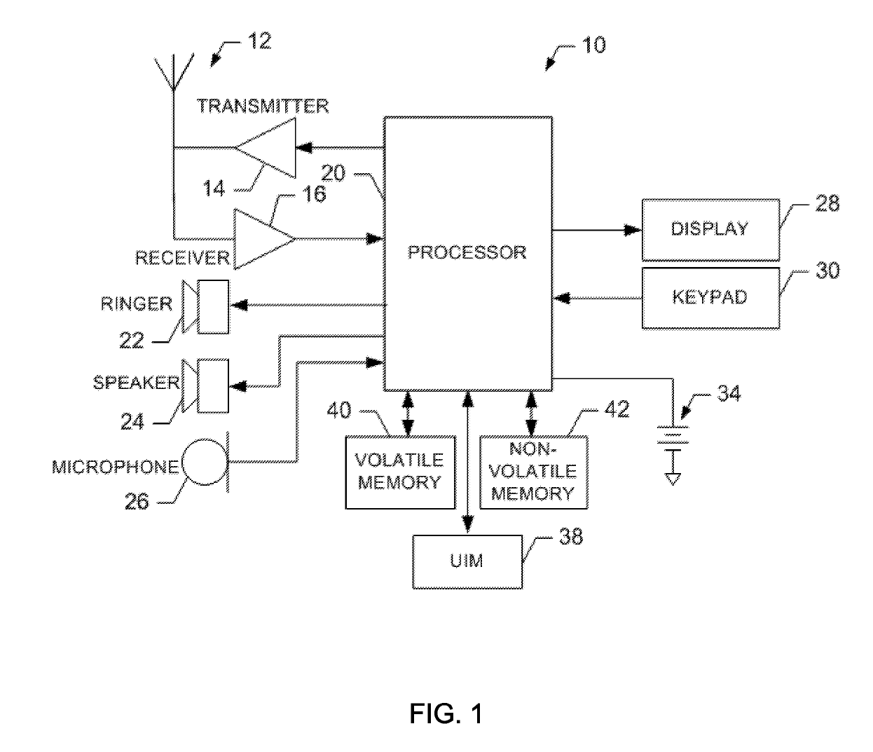

Turning now to FIG. 1, which provides one example embodiment, a block diagram of a mobile terminal 10 that would benefit from embodiments of the present invention is illustrated. It should be understood, however, that the mobile terminal 10 as illustrated and hereinafter described is merely illustrative of one type of device that may benefit from embodiments of the present invention and, therefore, should not be taken to limit the scope of embodiments of the present invention. As such, although numerous types of mobile terminals, such as portable digital assistants (PDAs), mobile telephones, pagers, mobile televisions, gaming devices, laptop computers, cameras, tablet computers, touch surfaces, wearable devices, video recorders, audio/video players, radios, electronic books, positioning devices (e.g., global positioning system (GPS) devices), sensors, objects, or any combination of the aforementioned, and other types of voice and text communications systems, may readily employ embodiments of the present invention, other devices including fixed (non-mobile) electronic devices may also employ some example embodiments.

As used in the description that follows, the term “object” refers to a smart object or any other physical object that is capable of communicating information to a network, such as the Internet. Such information may include data that is detected or measured by the object (e.g., temperature, humidity, acceleration, etc.), properties of the object (e.g., preferred communication protocols, a state of the object such as active or inactive, battery life, etc.), or any other data received or processed through the object. In some cases, the object may be a sensor that is configured to detect or measure a certain parameter. In other cases, the object may be a device that is configured to perform certain functions upon receiving user input, such as a smart phone, tablet computer, PDA, or other mobile or fixed user terminal, including the mobile terminal 10 of FIG. 1.

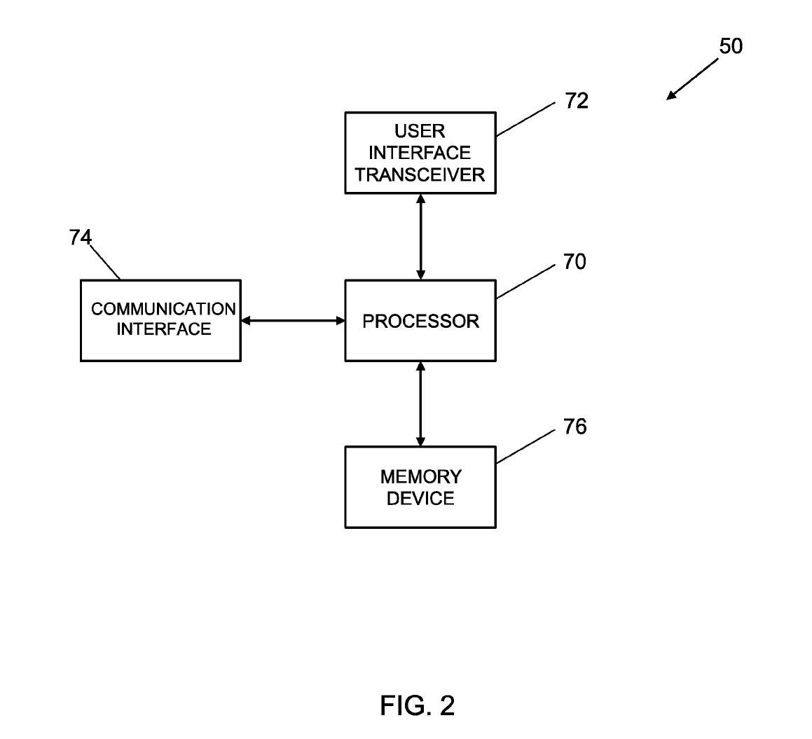

Referring again to FIG. 1, the mobile terminal 10 may include an antenna 12 (or multiple antennas) in operable communication with a transmitter 14 and a receiver 16. The mobile terminal 10 may further include an apparatus, such as a processor 20 or other processing device (e.g., processor 70 of FIG. 2), which controls the provision of signals to and the receipt of signals from the transmitter 14 and receiver 16, respectively. The signals may include signaling information in accordance with the air interface standard of the applicable cellular system, and also user speech, received data and/or user generated data. As an alternative (or additionally), the mobile terminal 10 may be capable of operating in accordance with non-cellular communication mechanisms. For example, the mobile terminal 10 may be capable of communication in a wireless local area network (WLAN) or other communication networks.

In some embodiments, the processor 20 may include circuitry desirable for implementing audio and logic functions of the mobile terminal 10. For example, the processor 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The processor 20 thus may also include the functionality to convolutionally encode and interleave message and data prior to modulation and transmission. The processor 20 may additionally include an internal voice coder, and may include an internal data modem. Further, the processor 20 may include functionality to operate one or more software programs, which may be stored in memory. For example, the processor 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the processor 20. The user input interface, which allows the mobile terminal 10 to receive data, may include any of a number of devices allowing the mobile terminal 10 to receive data, such as a keypad 30, a touch screen display (display 28 providing an example of such a touch screen display) or other input device. In embodiments including the keypad 30, the keypad 30 may include the conventional numeric (0-9) and related keys (#, *), and other hard and soft keys used for operating the mobile terminal 10. Alternatively or additionally, the keypad 30 may include a conventional QWERTY keypad arrangement. The keypad 30 may also include various soft keys with associated functions. In addition, or alternatively, the mobile terminal 10 may include an interface device such as a joystick or other user input interface. Some embodiments employing a touch screen display, as described further below, may omit the keypad 30 and any or all of the speaker 24, ringer 22, and microphone 26 entirely. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which may be embedded and/or may be removable. The memories may store any of a number of pieces of information, and data, used by the mobile terminal 10 to implement the functions of the mobile terminal 10.

An example embodiment of the invention will now be described with reference to FIG. 2, which depicts certain elements of an apparatus 50 for determining recommended actions based on contextual data. The apparatus 50 of FIG. 2 may be employed, for example, with the mobile terminal 10 of FIG. 1. However, it should be noted that the apparatus 50 of FIG. 2 may also be employed in connection with a variety of other devices, both mobile and fixed, such as a server as described below, and therefore, embodiments of the present invention should not be limited to application on devices such as the mobile terminal 10 of FIG. 1. For example, the apparatus 50 may be employed on a personal computer, a tablet, a mobile telephone, or other user terminal. Moreover, in some cases, part or all of the apparatus 50 may be on a fixed device such as a server or other service platform and the content may be presented (e.g., via a server/client relationship) on a remote device such as a user terminal (e.g., the mobile terminal 10) based on processing that occurs at the fixed device.

It should also be noted that while FIG. 2 illustrates one example of a configuration of an apparatus 50 for determining recommended actions based on contextual data, numerous other configurations may also be used to implement embodiments of the present invention. As such, in some embodiments, although devices or elements are shown as being in communication with each other, hereinafter such devices or elements should be considered to be capable of being embodied within a same device or element and, thus, devices or elements shown in communication should be understood to alternatively be portions of the same device or element.

Referring now to FIG. 2, the apparatus 50 for determining recommended actions based on contextual data may include or otherwise be in communication with a processor 70, a user interface transceiver 72, a communication interface 74, and a memory device 76. In some embodiments, the processor 70 (and/or co-processors or any other processing circuitry assisting or otherwise associated with the processor 70) may be in communication with the memory device 76 via a bus for passing information among components of the apparatus 50. The memory device 76 may include, for example, one or more volatile and/or non-volatile memories. In other words, for example, the memory device 76 may be an electronic storage device (e.g., a computer readable storage medium) comprising gates configured to store data (e.g., bits) that may be retrievable by a machine (e.g., a computing device like the processor 70). The memory device 76 may be configured to store information, data, content, applications, instructions, or the like for enabling the apparatus to carry out various functions in accordance with an example embodiment of the present invention. For example, the memory device 76 could be configured to buffer input data for processing by the processor 70. Additionally or alternatively, the memory device 76 could be configured to store instructions for execution by the processor 70.

The apparatus 50 may, in some embodiments, be a mobile terminal (e.g., mobile terminal 10) or a fixed communication device or computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the present invention on a single chip or as a single “system on a chip.” As such, in some cases, a chip or chipset may constitute means for performing one or more operations for providing the functionalities described herein.

The processor 70 may be embodied in a number of different ways. For example, the processor 70 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 70 may include one or more processing cores configured to perform independently. A multi-core processor may enable multiprocessing within a single physical package. Additionally or alternatively, the processor 70 may include one or more processors configured in tandem via the bus to enable independent execution of instructions, pipelining and/or multithreading.

In an example embodiment, the processor 70 may be configured to execute instructions stored in the memory device 76 or otherwise accessible to the processor 70. Alternatively or additionally, the processor 70 may be configured to execute hard-coded functionality. As such, whether configured by hardware or software methods, or by a combination thereof, the processor 70 may represent an entity (e.g., physically embodied in circuitry) capable of performing operations according to an embodiment of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing an embodiment of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network. Additionally or alternatively, the communication interface 74 may include the circuitry for interacting with the antenna(s) to cause transmission of signals via the antenna(s) or to handle receipt of signals received via the antenna(s). In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface transceiver 72 may be in communication with the processor 70 to receive an indication of a user input and/or to cause provision of an audible, visual, mechanical or other output to the user. As such, the user interface transceiver 72 may include, for example, a keyboard, a mouse, a joystick, a display, a touch screen(s), touch areas, soft keys, a microphone, a speaker, or other input/output mechanisms. Alternatively or additionally, the processor 70 may comprise user interface circuitry configured to control at least some functions of one or more user interface elements such as, for example, a speaker, ringer, microphone, display, and/or the like. The processor 70 and/or user interface circuitry comprising the processor 70 may be configured to control one or more functions of one or more user interface elements through computer program instructions (e.g., software and/or firmware) stored on a memory accessible to the processor 70 (e.g., memory device 76, and/or the like).

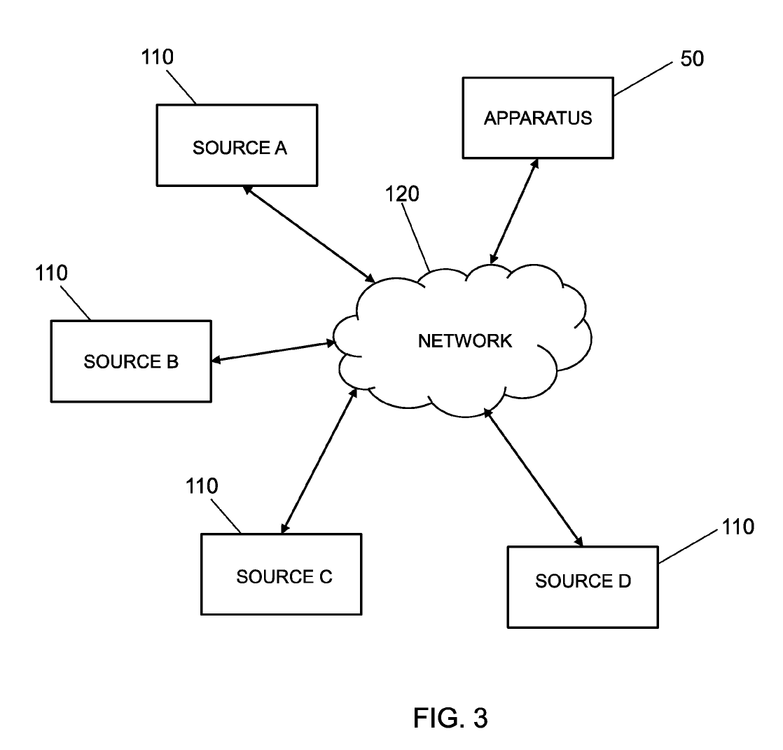

Embodiments of the invention will now be described with reference to FIG. 3. As noted above, a user's situation, or the set of circumstances under which the user must make certain decisions and take certain corresponding actions, can often be discovered with reference to contextual data. Contextual data can come from a variety of sources and provides information regarding the user's situation. For example, the contextual data can include data detected by one or more sensors in the vicinity of the user (e.g., on the user's person, in the same room as the user, in the same building that the user is in, etc.). Such sensors may include, for example, temperature sensors configured to measure the temperature in the user's location (e.g., in the room in which the user is located); humidity sensors configured to measure the level of humidity in the user's location; accelerometers configured to measure aspects of the user's movement; GPS sensors configured to determine a location of the user; motion sensors configured to measure movement within a certain area; proximity or presence sensors, such as those using Bluetooth Low Energy, that can detect the nearness or presence of certain objects to the user, and so on. In this regard, in some embodiments, the contextual data may include data received from a mobile terminal (e.g., a smart phone) associated with the user.

Additionally or alternatively, contextual data may include data received from a remote source regarding a location of the user. For example, such contextual data may include aspects of a weather forecast as determined by a third party source, such as outside temperature, wind chill factor, dew point, chance of rain, etc.; an events calendar distributed by a city's news media, such as describing concert events, festivals, etc. for a particular location; traffic reports, such as reporting on traffic accidents, delays, road closures, construction, etc.; as well as any other data from any other source that provides information regarding the user's situation.

With reference to FIG. 3, one or more of the sensors and other information sources 110 that describe the user's situation may be objects that are configured to communicate with an apparatus 50 (e.g., the apparatus of FIG. 2) over a network 120 according to some embodiments of the invention. For example, Source A in FIG. 3 may be a GPS locator in the example described above that is configured to transmit information regarding the user's present location, and Source B may be an outdoor thermometer hanging outside the user's front door. Similarly, Source C may be a local news forecast (e.g., local with respect to the location information provided by Source A), and Source D may be the user's calendar, which may include the user's scheduled appointments for the day. Each contextual data source 110 may be configured to communicate contextual data (e.g., data regarding the user's situation at a given point in time) to the apparatus 50 via the network 120.

In this example, Source A (the GPS transmitter) may communicate contextual data that includes the user's current geographic location. Source B (the thermometer) may communicate contextual data that the current outside temperature in a certain location (e.g., outside the user's home). Source C (the news forecast) may communicate contextual data that includes one or more aspects of the local weather forecast, such as the current and expected temperature, wind chill, dew point, etc. And Source D in this example (the user's calendar) may communicate contextual data that includes the times of the user's appointments for the day, the locations of the appointments, the people with whom the user has scheduled meetings, and so on.

Thus, as described above, a source 110 may be a sensor that is configured to detect or measure a certain parameter in the vicinity of the user, a mobile terminal associated with the user, or a remote device, memory, server, etc. that is configured to provide contextual data regarding the user's situation. In this regard, the source 110 may comprise a communication interface that is configured to at least transmit the information to the apparatus 50, such as via the network 120 (e.g., the Internet). As noted above, in some cases, the source 110 may be a repository of information, which may be configured by one or more third parties, and may transmit one or more pieces of contextual data directly or indirectly, to the apparatus 50. The contextual data may be stored, analyzed, manipulated, etc. in a memory of the apparatus 50 or a separate memory accessible to the apparatus. In other cases, however, the source 110 may include its own memory device, a processor, a user input transceiver, user input devices, etc., such as when the source is, for example, a mobile terminal such as the mobile terminal 10 shown in FIG. 1.

Accordingly, embodiments of the invention provide mechanisms for recommending actions to be taken by the user based on contextual data. In this regard, the apparatus 50 may comprise at least one processor 70 and at least one memory 76 including computer program code, as shown in FIG. 2. The at least one memory 76 and the computer program code may be configured to, with the processor 70, cause the apparatus 50 to at least receive contextual data regarding a user's situation (e.g., data received from sensors devices and/or mobile terminals associated with the user, and/or remote sources). The at least one memory and the computer program code may be configured to, with the processor, determine at least one recommended action to be taken by the user based on the contextual data and provide the at least one recommended action to the user, as described in greater detail below.

In some cases, for example, the at least one memory and the computer program code may be configured to, with the processor, cause the apparatus to receive user data regarding an action taken by a user, wherein the user data is associated with corresponding contextual data. In this regard, the user data may be data describing how the user acts in a particular situation (e.g., a situation described by certain contextual data). In some embodiments, the user data regarding an action taken by the user may comprise, for example, an indication of an object being in proximity to the user. The objects may be, for example, devices carried by the user (e.g., a watch, a phone, a book, etc.), articles of clothing, a car, a household appliance, etc.

In some embodiments, for example, the user's smart phone may be equipped with one or more cameras that are configured to capture images of the user, and the images may be analyzed (e.g., by a processor of the smart phone or a remote processor in communication with the smart phone) to identify the clothing or type of clothing worn by the user, personal effects carried by the user (e.g., a backpack, purse, laptop bag, sweater, etc.), etc. As another example, certain items, appliances, fixtures, machines, devices, etc. that the user interacts with may be smart objects that are connected to the IoT. As a result, the user's interactions with these objects may be monitored and provided to the apparatus 50 as user data describing the user's actions. As yet another example, sensors in the area of the user (such as the sensors used to detect and provide contextual data) may also be used to detect the user's actions and provide user data (e.g., via proximity sensors, motion sensors, accelerometers, pedometers, etc.).

The user data that is obtained and communicated to the apparatus 50 in some embodiments may be associated with corresponding contextual data. In other words, the action described by the user data was taken under a certain set of circumstances defining a particular situation of the user, and that situation is described by contextual data. For example, when the weather is cold outside, the user may typically wear a sweater. In this simple example, the user data may be images from the user's smartphone indicating that the user put on a sweater, and this user data may be associated with contextual data including the air temperature in the user's geographic location, the wind speed, the wind chill factor, the humidity, and/or the precipitation index, all of which may inform how cold the user may perceive the weather to be.

In some embodiments, the at least one memory and the computer program code may be configured to, with the processor, cause the apparatus to provide for storage of the user data received and the associated contextual data. The at least one memory and the computer program code may be further configured to, with the processor, cause the apparatus to determine the at least one recommended action to be taken by the user based on stored user data associated with stored contextual data that corresponds to the contextual data received. In this regard, the at least one recommended action may be automatically determined, that is, without manual intervention.

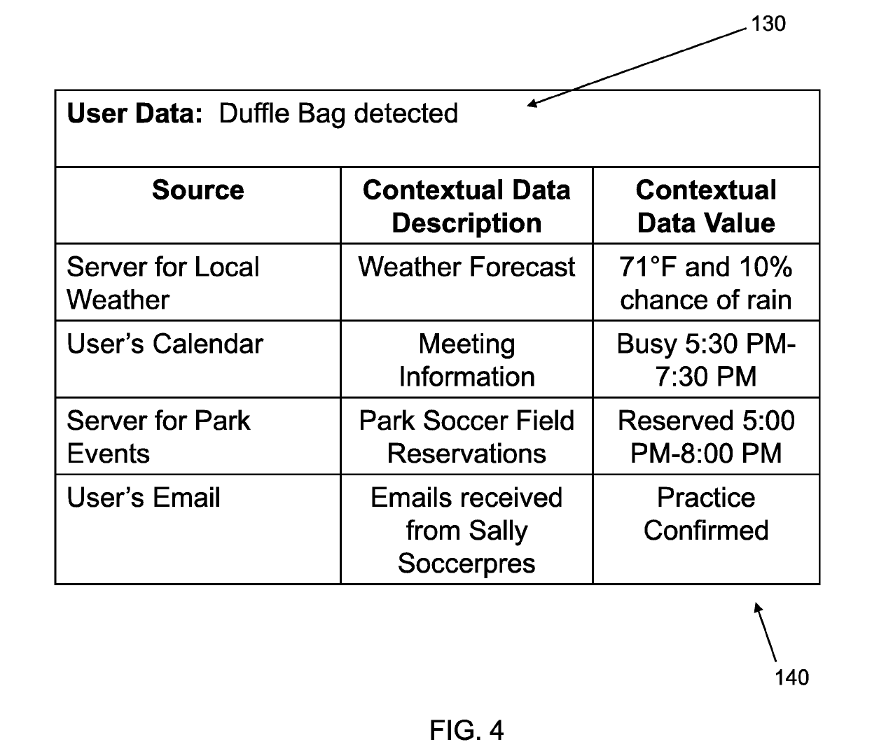

For example, turning to FIG. 4, user data 130 may be received (e.g., from a proximity sensor on the user's smart phone, which is typically carried on the user's person when the user leaves his or her home) that indicates that a certain duffle bag (which may be equipped with a transmitter configured to send signals that can be detected by the proximity sensor) is near (e.g., being carried by the user). Upon receipt and storage of this user data 130, for example, corresponding contextual data 140 may be associated with the user data. The contextual data 140 may be considered corresponding contextual data because the contextual data was received at substantially the same time and/or place as the receipt of the user data 130, or for some other reason or combination of reasons is considered relevant to the user data as explaining why the user took the action (e.g., in this example, why the user brought his or her duffle bag). In the simple example depicted in FIG. 4, the contextual data 140 may include data from a source of weather information regarding the day's weather in the user's location; the user's calendar indicating that a block of time from 5:30 PM to 7:30 PM is blocked out for “soccer practice”; a source of local event information for a park that is typically reserved for the user's league's soccer practice; and the user's email, which generally receives on the night before soccer practice an email from the league president confirming the following day's practice schedule.

Although FIG. 4 depicts a single piece of user data 130 and only four pieces of contextual data 140 associated with the user data, numerous pieces of user data 130 may be received regarding various actions taken by the user over the course of a day, weeks, months, etc. Moreover, each piece of user data 130 may be associated with various amounts of corresponding contextual data 140, such the user's situation when the user took action may be known or described in a greater or lesser level of detail, accordingly.

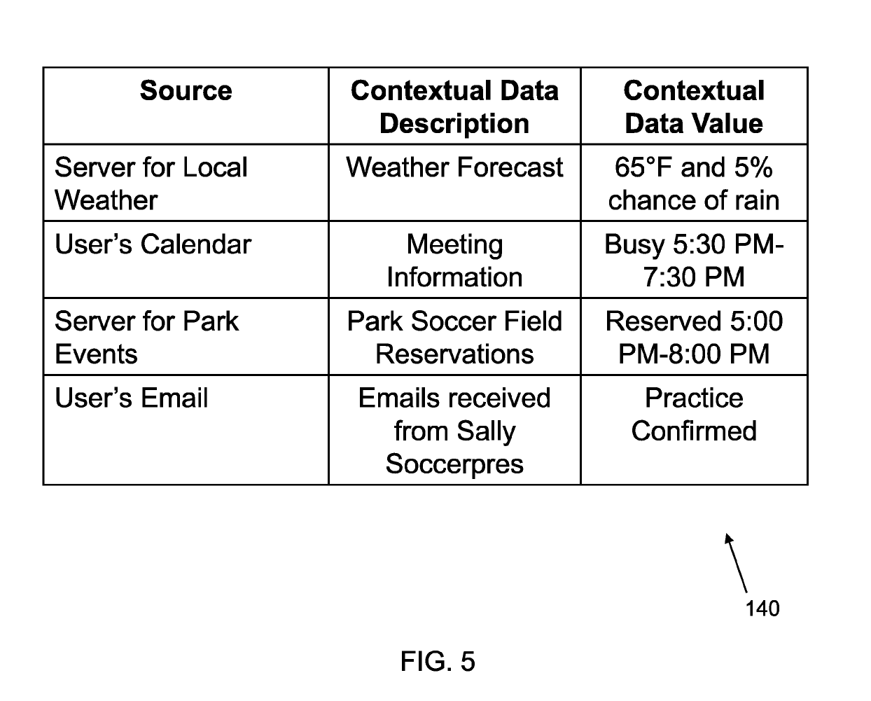

With respect to the example described above and illustrated in FIG. 4, in which the user takes his or her duffle bag when leaving home on Wednesday mornings on days that there is soccer practice, contextual data may be received on a particular Wednesday morning as shown in FIG. 5. The contextual data received (shown in FIG. 5) may be for example, a weather forecast of 65° F. and 5% chance of rain; a block of time marked as busy in the user's calendar from 5:30 PM-7:30 PM; a soccer field reservation; and an email received from the soccer league president confirming that practice will take place. As noted above, the at least one recommended action to be taken by the user may be determined based on stored user data associated with stored contextual data (an example of both of which are shown in FIG. 4). Thus, in this example, because the weather server, the user's calendar, the park reservation system, and the user's email all provide indications similar to those found in the stored contextual data 140 in FIG. 4, the apparatus may be caused (e.g., via the processor) to determine that the recommended action to be taken by the user is the same action described by the stored user data 130 in FIG. 4. Accordingly, in this example, the recommended action would be for the user to take his or her duffle bag. In this regard, how “similar” data must be to qualify as a match triggering the same user data to be recommended as the action to be taken may be predefined by the user and/or pre-configured by the system and may depend on the type of source from which the data is received, the type of contextual data, and so on.

In some embodiments, the at least one memory and the computer program code may be configured to, with the processor, cause the apparatus to provide for storage of the user data received and the associated contextual data, as noted above with respect to FIG. 4, and the apparatus may further be caused to determine a relationship between the user data and the associated contextual data, such that the at least one recommended action to be taken by the user is determined based on the relationship determined.

For example, the apparatus may be caused (e.g., via the processor) to automatically, e.g., without manual intervention, detect patterns in how the user reacts to certain situations (as described by the contextual data). Taking the soccer example above, one relationship that may be identified may be that when the weather forecast includes a temperature of 40° F. or higher, and all other indications are that soccer practice will be taking place, regardless of the chance of rain, the user takes his or her duffle bag and attends soccer. When the temperature drops to below 40° F., however, even if there is no chance of rain and all other indications are that soccer practice will be taking place, the user does not take his or her duffle bag (e.g., because the user chooses to skip practice due to the cold weather).

The relationships that may be determined by the apparatus based on an analysis of the stored contextual data and the stored user data may be much more complex than those used in the example above and may take into account the length of time over which the data is stored, the number of data points, differences in the sources of data and combinations of sources over that time, and user preferences for the analysis. In this regard, the user may be able to provide input as to how the data should be analyzed, such as by indicating the time period for the analysis, which sources should be considered, how the sources should be weighed relative to each other, etc.

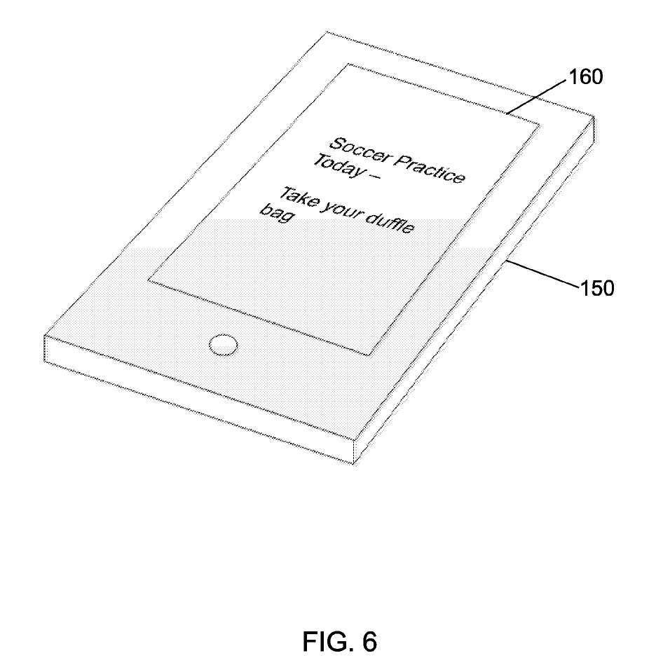

The at least one memory and the computer program code may be configured to, with the processor, cause the apparatus of an example embodiment to provide the at least one recommended action to the user, thereby notifying the user of the recommended action. The user may be notified of the recommended action in various manners. As shown in FIG. 6, for example, a mobile terminal 150, such as of the type described above in conjunction with FIG. 1, may include a display 160. In this example, the at least one memory and the computer program code may be configured to, with the processor, cause display of the notification to the user. Additionally or alternatively, the notification may be provided by an alert, an audio alarm, an announcement or the like, such as may be generated by the mobile terminal. As noted above, the recommended action may be any of a number of actions that the system determines may be advisable for the user to take based on the circumstances. In some cases, for example, the recommended action may comprise the user bringing a particular item to a destination, such as packing a particular garment or device in a suitcase the night before a business trip, carrying a particular item (e.g., a laptop or briefcase) to work on a particular day, etc.

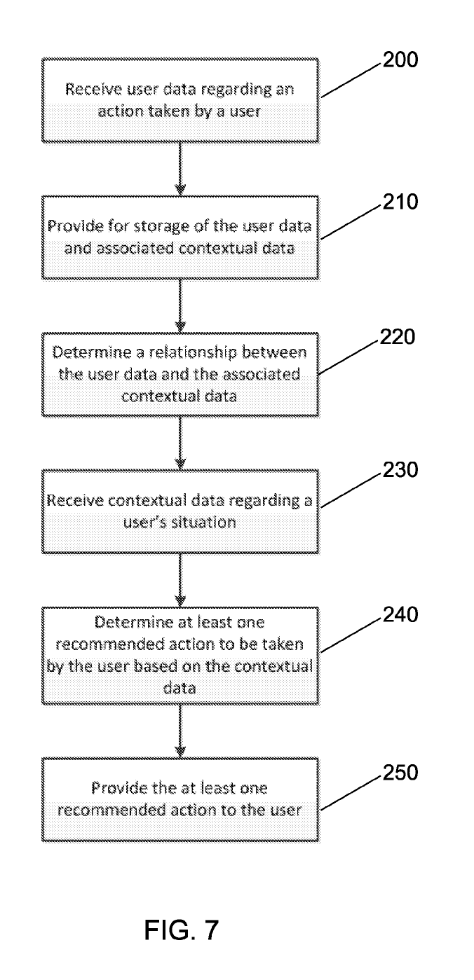

FIG. 7 illustrates a flowchart of systems, methods, and computer program products according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory device of an apparatus employing an example embodiment of the present invention and executed by a processor in the apparatus. As will be appreciated, any such computer program instructions may be loaded onto a computer or other programmable apparatus (e.g., hardware) to produce a machine, such that the resulting computer or other programmable apparatus implements the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s).

Accordingly, blocks of the flowchart support combinations of means for performing the specified functions, combinations of operations for performing the specified functions, and program instruction means for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, one example embodiment of a method for determining a recommended action to be taken by a user based on contextual data is shown in FIG. 7. FIG. 7 depicts an example embodiment of the method that includes receiving contextual data regarding a user's situation at block 230. The contextual data may be provided by various sources, such as by at least one sensor in the vicinity of the user and/or by a mobile terminal associated with the user. Based upon the contextual data, the method may determine at least one recommended action to be taken by the user at block 240. The method of this embodiment also includes providing the at least one recommended action to the user at block 250, such as via a display of the recommended action as shown in FIG. 6.

The method may determine the at least one recommended action based on the contextual data in various manners. As shown in FIG. 7, for example, the method may receive user data regarding an action taken by the user at block 200. In this example, the user data is associated with corresponding contextual data. As shown in block 210 of FIG. 7, the method may provide for storage of the user data and the associated contextual data. As such, the method may determine the at least one recommended action to be taken by the user at block 240 based on stored user data associated with stored contextual data that corresponds to the contextual data received. For example, the method may determine, based upon correspondence between the stored contextual data that is associated with the user data and the contextual data that has been received, what the user has done in the same or a contextually similar situation as represented by the user data.

Alternatively, the method may optionally determine a relationship between the user data and the associated contextual data as shown in block 220 of FIG. 7. In this example embodiment, the method may determine the at least one recommended action to be taken by the user at block 240 based on the relationship. By way of example, the contextual data that is received may be determined to correspond to the stored contextual data with the at least one recommended action then being determined based upon the user data that is identified as a result of the relationship between the user data and the stored contextual data.

In some embodiments, certain ones of the operations above may be modified or further amplified as described below. Furthermore, in some embodiments, additional optional operations may be included. Although the operations above are shown in a certain order in FIG. 7, certain operations may be performed in any order. In addition, modifications, additions, or amplifications to the operations above may be performed in any order and in any combination.

In an example embodiment, an apparatus for performing the methods of FIG. 7 above may comprise a processor (e.g., the processor 70 of FIG. 2) configured to perform some or each of the operations (200-250) described above. The processor may, for example, be configured to perform the operations (200-250) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 200 and 230 may comprise, for example, the processor 70, the user interface transceiver 72, the communication interface 74 and/or a device or circuit for executing instructions or executing an algorithm for processing information as described above. Examples of means for performing operation 210 may comprise, for example, the processor 70, the memory device 76 and/or a device or circuit for executing instructions or executing an algorithm for processing information as described above. Examples of means for performing operations 220 and 240 may comprise, for example, the processor 70 and/or a device or circuit for executing instructions or executing an algorithm for processing information as described above. Examples of means for performing operation 250 may comprise, for example, the processor 70, the user interface transceiver 72 and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. For example, although the depicted embodiments are explained in conjunction with a subsequent soccer practice such that the user data may include the user taking a duffle bag to work and the contextual data may include the weather forecast, the schedule for the soccer field and a prior email regarding the impending soccer practice, it is understood that various different user activities may benefit from embodiments of the present invention. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. An apparatus comprising at least one processor and at least one memory including computer program code, the at least one memory and the computer program code configured to, with the processor, cause the apparatus to at least:
receive contextual data regarding a user's situation;
correlating the user's situation with a particular object;
determine at least one recommended action to be taken by the user based on the contextual data, wherein the at least one recommended action comprises an action that incorporates the particular object; and
provide the at least one recommended action to the user.

2. The apparatus of claim 1, wherein the contextual data comprises data detected by at least one sensor in a vicinity of the user.

3. The apparatus of claim 1, wherein the contextual data comprises data received from a mobile terminal associated with the user.

4. The apparatus of claim 1, wherein the at least one memory and the computer program code are configured to, with the processor, cause the apparatus to receive user data regarding an action taken by the user, wherein the user data is associated with corresponding contextual data.

5. The apparatus of claim 4, wherein the user data regarding an action taken by the user comprises an indication of an object being in proximity to the user.

6. The apparatus of claim 4, wherein the at least one memory and the computer program code are configured to, with the processor, cause the apparatus to provide for storage of the user data received and the associated contextual data and further cause the apparatus to determine the at least one recommended action to be taken by the user based on stored user data associated with stored contextual data that corresponds to the contextual data received.

7. The apparatus of claim 4, wherein the at least one memory and the computer program code are configured to, with the processor, cause the apparatus to provide for storage of the user data received and the associated contextual data and further cause the apparatus to determine a relationship between the user data and the associated contextual data, such that the at least one recommended action to be taken by the user is determined based on the relationship determined.

8. The apparatus of claim 1, wherein the at least one memory and the computer program code are configured to, with the processor, cause the apparatus to provide the at least one recommended action to the user by causing display of a notification to the user.

9. apparatus of claim 1, wherein the recommended action comprises the user bringing a particular item to a destination.

10. A method comprising:
receiving contextual data regarding a user's situation;
correlating the user's situation with a particular object;
determining at least one recommended action to be taken by the user based on the contextual data, wherein the at least one recommended action comprises an action that incorporates the particular object; and
providing the at least one recommended action to the user.

11. The method of claim 10, wherein the contextual data comprises data detected by at least one sensor in a vicinity of the user.

12. The method of claim 10, wherein the contextual data comprises data received from a mobile terminal associated with the user.

13. The method of claim 10 further comprising receiving user data regarding an action taken by the user, wherein the user data is associated with corresponding contextual data.

14. The method of claim 13, wherein the user data regarding an action taken by the user comprises an indication of an object being in proximity to the user.

15. The method of claim 13 further comprising providing for storage of the user data received and the associated contextual data, wherein determining the at least one recommended action is based on stored user data associated with stored contextual data corresponding to the contextual data received.

16. The method of claim 13 further comprising providing for storage of the user data received and the associated contextual data and determining a relationship between the user data and the associated contextual data, such that the at least one recommended action to be taken by the user is determined based on the relationship determined.

17. The method of claim 10, wherein providing the at least one recommended action to the user comprises causing display of a notification to the user.

18. The method of claim 10, wherein the recommended action comprises the user bringing the particular object to a destination.

19. A computer program product comprising at least one computer-readable storage medium having computer-executable program code portions stored therein, the computer-executable program code portions comprising program code instructions for:
receiving contextual data regarding a user's situation;
correlating the user's situation with a particular object;
determining at least one recommended action to be taken by the user based on the contextual data, wherein the at least one recommended action comprises an action that incorporates the particular object; and providing the at least one recommended action to the user.

20. The computer program product of claim 19, wherein the contextual data comprises data detected by at least one sensor in a vicinity of the user.

21-34. (canceled)
